(19) United States
(12) Patent Application Publication
(10) Pub. No.: US 2005/0243063 A1
(43) Pub. Date: Nov. 3, 2005

(54) Method and device for displaying programmable-duration time intervals

(76) Inventor: Christian Mauron, Vinzel (CH)

Correspondence Address: STURM & FIX LLP, 206 SIXTH AVENUE, SUITE 1213, DES MOINES, IA, 50309-4076, US

(21) Appl. No.: 11/145,739

(22) Filed: Jun. 6, 2005

(30) Foreign Application Priority Data
Dec. 6, 2002 (EP) 02406071.7

(51) Int. Cl. G09G 5/08

(52) U.S. Cl. 345/159

(57) ABSTRACT

The invention relates to a method and device for displaying programmable-duration time intervals. The inventive method can be used to display programmable-duration time intervals throughout at least one time scale of a given length, using a cursor which moves from one end of said time scale to the other at a speed that is dependent on the duration of each programmed time interval. The programmed time interval is divided into at least two respective time segments having different proportions in relation to the distances to be traveled by the cursor. Subsequently, the speed of the cursor is adapted according to the distances to be traveled and the aforementioned respective time segments.

The present invention pertains to a method of displaying programmable-duration time intervals along at least one time scale of given length, with the aid of a cursor which moves from one end to the other of said scale with a speed dependent on the duration of each programmed time interval, as well as to a display device comprising at least one time scale of given length, a cursor able to move along said scale and means of control of said cursor to determine its speed of movement as a function of a time interval of determined duration.

A method and a device of this kind have already been proposed in FR 2,600,788. The use of this method and of this device have shown that it gives a much more immediate perception of time than is made possible with the conventional means of display in which a mobile member moves at constant speed opposite a graduated scale of indefinite length, so that the observer must determine where the end of the duration is situated on the graduated scale as a function of the duration to be measured and, thereafter, observe the movement of the mobile member with respect to the end of the duration chosen on this scale. This makes it necessary to memorize several data and to compare these data so as to assess the time remaining of the interval chosen at the outset.

In U.S. Pat. No. 4,995,018 there is also proposed a method and an apparatus for measuring the delivery of a talk, comprising a rectangular panel carrying a row of luminescent diodes distributed into three groups of different colors, each corresponding to a portion of the talk. A microcontrol is devised to activate electroluminescent diodes one after another and adjustments serve to control the instants at which the diodes are lit in each group. The color of a lit diode informs the speaker at a glance which portion of the talk he ought to be delivering at present.

Such a device is a system which remains entirely static. For example, at the conclusion of his talk, the speaker knows that he is in this concluding part. However, assuming that this part corresponds to one, two or five minutes, he does not know, without looking at his watch at the precise moment at which the diode corresponding to this last part lights up, how much time has elapsed since the diode lit up. Even if there are several diodes for this concluding part, nothing indicates the time for which the last diode has been lit and how much more time will elapse up to the end.

Furthermore, the design of such a system implies that each segment for displaying the talk is proportional to the length of the corresponding portion of the talk. The shorter this portion, the fewer diodes there are to display it. Even by increasing the number of diodes, nothing of this principle on which this device is based is changed. Now, it is known that, conversely, the shorter the instant to be measured, like the concluding part of a talk at a meeting or a determined-duration piece of work, the more the observer concerned must have a perception of the time that passes and be able to constantly see the remaining time still to elapse and to physically perceive, with no reasoned deduction, the time remaining up to the termination of the time allotted, with great accuracy, this not being made possible by a device such as that described in U.S. Pat. No. 4,995,018.

There exists a large number of human activities in the course of which a person has a determined time to accomplish a specific task in the course of which it is very difficult, simultaneously, to evaluate the time elapsed and the time remaining by the conventional means of display while continuing with this specific task. Such is the case in respect of a conference speaker to whom a determined time interval is granted and who must structure his lecture as a function of this time interval. Such is the case for journalists who make live radio or television broadcasts, for a candidate in an examination, in particular, and for all the activities for which high concentration is indispensable, although they must be performed in a determined time span. Now, the maximum efficiency cannot be brought to these tasks unless the person who executes them is able to constantly and immediately assess the time elapsed and that remaining at his disposal, thereby allowing him to organize his lecture or his work in an optimal manner.

Experience has demonstrated that the movement of a cursor over a time scale, at a speed dependent on the time interval to be measured, allows this immediate assessment, this not being possible with the conventional means of display.

Numerous tests of this kind have been carried out, which have made it possible to demonstrate the advantages of this mode of measuring time. Thus, tests have been done with children of preschool age who have immediately perceived the time-space given to them to do a drawing for example and who have thus occupied the allotted time very well. Trials have also been done with children regarded as too slow and for whom this mode of display has enabled them to manage time better and to overcome their handicap.

This mode of display has also been tested in respect of the continuous recording of series of television transmissions, carried out under live conditions. In respect of radio transmissions, this mode of display has made it possible to show its effectiveness in perfect management of the improvisation of a text of short and precise duration (for example of the order of a few tens of seconds). The same finding was also observed within the framework of recordings of improvised music within a given time.

In the course of conferences, it has been found that the infamous and traditional overrunning of the speaking time practically disappears. Numerous other examples could be cited.

The explanation for this finding is simple. It is to be sought in the realm of the mode of operation of the brain. When there is an activity which involves thinking, logical deduction, reasoning, such obviously being the case for a conference speaker, for a person taking examinations, or for a journalist who works live on radio or television, it is essentially the left hemisphere his brain which works. When he has to read the time on a conventional display to evaluate the time that has passed and that remaining, he uses the same left hemisphere, so that there is interference between the work that this person does and the evaluation of the time, passed and remaining, to enable him to best structure his lecture or his work. In the case of a lecture, this interference may cause the thread of the talk to be lost. However above all, this complex mode of display does not make it possible to organize the work or the lecture as a function of the time elapsed and of the time remaining, on account of the fact that the numerals indicated by the hands on a watch dial do not give an immediate picture of the amount of time elapsed and of that remaining to accomplish the task or the lecture, which can only be assessed by deduction, that is to say with the aid of the left hemisphere of the brain.

In the case of tasks to be accomplished in a precise time interval, the big problem is to complete this task at the exact end of this interval, since in order to complete a piece of work in a determined interval, it is necessary to prepare the conclusion of the lecture a certain time before the end of the time allocated, failing which, either the conclusion will be hasty, or the time will be overrun. In this regard, it has been found that over relatively long durations, of several tens of minutes in particular, the last few instants of the time interval available are difficult to evaluate, having regard to the proximity of the cursor with respect to the terminal end of the scale for measuring the time interval.

The aim of the present invention is to afford a solution which makes it possible in particular to remedy this drawback and which further improves the psychological perception of time.

Accordingly, the present invention is firstly directed at a method of displaying programmable-duration time intervals along at least one time scale of given length. This invention is thereafter directed at a device for displaying programmable-duration time intervals, comprising at least one time scale of given length.

The display method and device according to the present invention afford an appreciable improvement in relation to all devices for displaying programmable time intervals. They enable, in particular, each user to distribute the various respective time portions and to organize them at will, not everyone having the same perception of time, so that it is important to enable each user to organize the display of the various time portions as a function of his requirements, of the duration of the interval and of the task to be accomplished in particular.

The appended drawings illustrate, diagrammatically and by way of example, a form of execution and various modes of implementation of the method and of the device for displaying programmable-duration time intervals, which are the subject of the present invention.

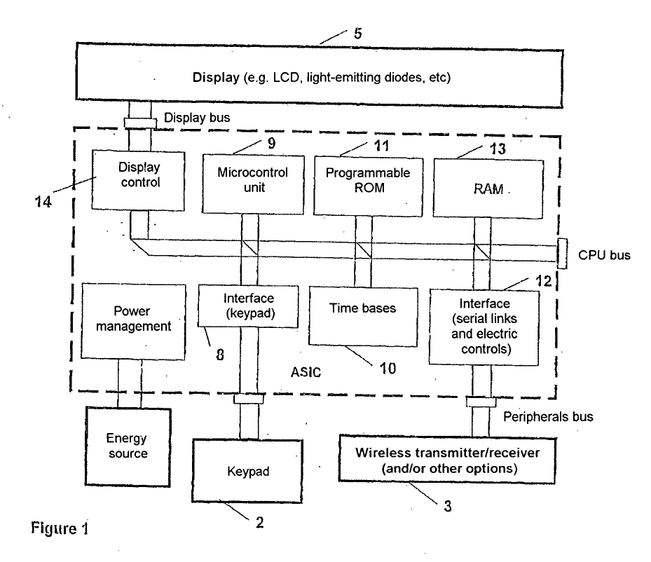

FIG. 1 is a block diagram of the control circuit of the display device;

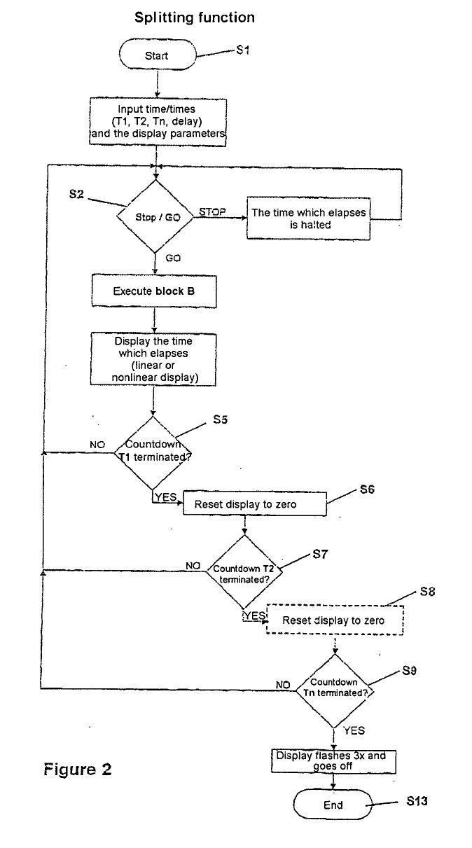

FIG. 2 is a function diagram illustrating the functioning of the control circuit of FIG. 1;

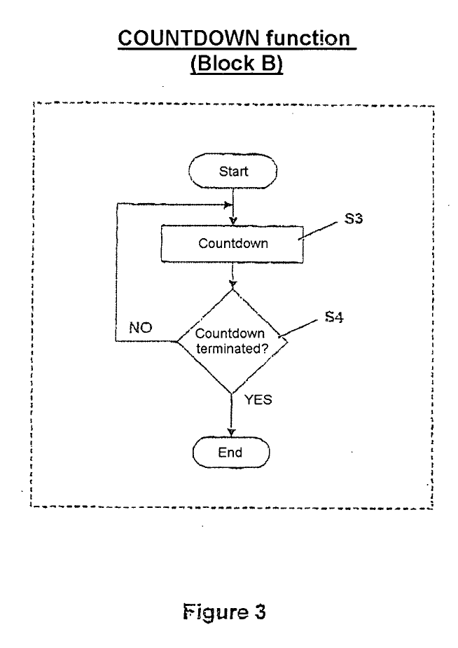

FIG. 3 is a function diagram of a detail of FIG. 2;

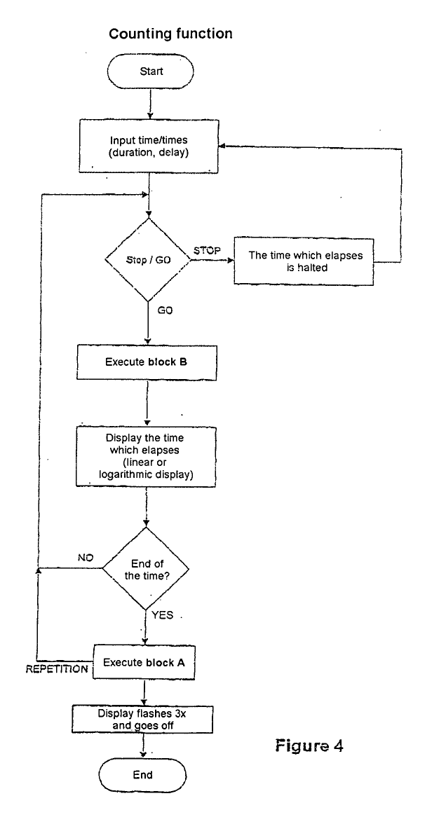

FIG. 4 is a function diagram illustrating just the counting with repetition of the time measured of the control circuit of FIG. 1;

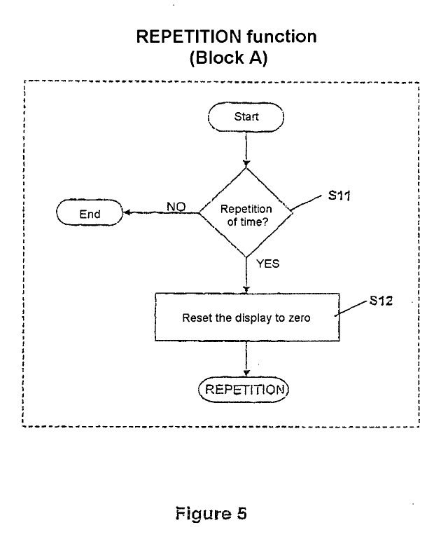

FIG. 5 is a function diagram of a detail of FIG. 4.

The display device, the subject of the present invention, which is illustrated by FIG. 1, comprises, in this example, an application specific integrated circuit, generally better known by the initials ASIC, which is connected by various buses 1 to a keypad 2, to a remote control comprising a transmitter/receiver 3, to a central processing unit 4, generally designated by the initials CPU, and to a display member 5, which preferably takes the form of a time scale formed of a rectilinear or nonrectilinear segment consisting, for example, of a liquid crystal display, a row of light-emitting diodes, or any equivalent means of display. In all cases, the display will comprise a line separating two portions of the segment forming the display member, this line moving from one end to the other of the rectilinear or nonrectilinear segment. The two portions of the segment will preferably have two different colors, so as to give the best possible perception of the ratio of the length between the two portions of the segment for display of the time interval, and above all of the rate of change of these two ratios, characterizing the flow of time in the interval measured between the time elapsed and the time remaining.

The time scale constituting the display member 5 has a determined length, regardless of the time interval to be measured. It is the speed of the cursor along this time scale which will vary as a function of the duration of the time interval and of the fixed length of this time scale.

The ASIC comprises a power management element 6 linked to an energy source 7, an interface 8 between the keypad 2 and a microcontrol unit 9, a time base 10 linked to a programmable ROM 11, an interface 12 (serial links and electric controls) between the transmitter/receiver 3 and a RAM 13 and finally a display control 14 linked to the display member 5.

We shall now describe with the aid of the function diagrams of FIGS. 2 to 5 the mode of functioning of the display device described in conjunction with the block diagram of FIG. 1. To perform the method of display which is the subject of the present invention, it is necessary to firstly enter the duration of the time interval to be measured, either with the aid of the keypad 2, or with the aid of the remote control 3. It will be appropriate to choose the function relating to the mode of display. Several choices are possible. The main choice will be between a linear or nonlinear display and with or without the function of the division of the time interval.

It is in fact possible to choose that the cursor which consists of the line of separation between the two zones of different colors of the display segment 5 move in a linear manner from one end of the rule to the other of this segment 5. In this case, it will be appropriate to choose a division of this interval, preferably into two unequal portions, a first portion representing the major part of the interval to be measured and a final portion of this interval. The display of these two time portions will be done in the following manner. The speed of the cursor during the display of the first portion will correspond to the linear speed of the cursor for traversing the whole of the display segment as a function of the total duration of the interval. When the cursor has traversed the portion of the display segment 5 proportional to the first time portion, the cursor is returned to the start of the display segment 5 and then traverses the whole of the display segment 5 at a speed proportional to that of the second time portion of the total time interval, which is substantially shorter than the first time portion, so that the cursor will have a markedly higher speed than that which it had during the display of the first time portion.

In a variant, the two time portions will also be displayable on two different display segments 5. The latter may be of the same length or otherwise and will preferably have different display colors, so as to give the user additional information to enable him to distinguish between the first or the second period of time.

It is also possible to choose a nonlinear display of the time interval. In this case, the idea consists, preferably, in reducing the speed of movement of the cursor between the start and the end of the display segment 5. Preferably, the curve of variation of speed will be continuous from the start to the end, so that the variation of speed is not perceptible. This amounts in fact to dividing the display segment into a plurality of micro-segments each of which has a speed which decreases with respect to the previous one. Advantageously, this curve of variation of speed as a function of the interval will be calculated by the electronic control circuit. Of course, it will be possible, conversely to the example described hereinabove, to increase the speed of movement of the cursor between the start and the end of the display segment.

In practice, the time interval to be measured will be divided into a large number n of micro-intervals whose durations increase progressively from the first to the n^{th} micro-interval, these micro-intervals being displayed on respective equal fractions of said time scale, dependent on the length of said time scale divided by said number n.

The choice of this mode of display may be combined or otherwise with the separation of the time interval into two unequal portions as explained hereinabove. In this case, the first portion of the display corresponding to the major part of the total time will be displayed with a nonlinear speed, while the second portion will be displayed at a linear speed over the whole length of the display segment 5, proportional to the length of this second portion of time of the total interval to be measured, as in the case explained previously.

Once the desired display parameters have been entered, the display device can be switched on, at the desired moment or with deferral of the start by a determined duration, chosen by the user at the moment at which he enters the parameters into the device.

In either case, that is to say with or without programmed delay for the start of the measurement of the time interval, the first step S1 corresponds to switch-on which goes to the second step S2, which determines whether the start of the measurement of the programmed time interval is or is not deferred.

If the time is deferred, the time which elapses is halted until a duration corresponding to the desired delay has elapsed. Thereafter, the order is given to the time countdown block B to commence the countdown. The function of this block B is illustrated by FIG. 3. It consists in performing the countdown of the time as soon as it has been ordered by S2 to start the count. This countdown is performed in step S3 and we determine in step S4 whether or not the countdown has terminated.

Once this countdown has terminated, we go to the next step S5 which must determine whether the countdown of the time T1 corresponding to the first portion of the time interval has or has not terminated. If the countdown relating to this first portion of time has terminated, we go to a first reset to zero of the cursor of the display device in step S6, which simultaneously triggers step S7 which must determine whether the countdown relating to the second time portion T2 has terminated. If the time interval has been divided into two, the end of the countdown of the portion T2 orders the second reset to zero of the cursor of the display member, corresponding to step S8.

If the time interval is divided into a large number n of micro-intervals, as in the case of the nonlinear movement of the cursor, step S9 serves to determine the moment at which the countdown corresponding to the number n of micro-intervals has terminated. In this case, the reset to zero will be done after this step S9.

FIG. 4 illustrates the only function of counting of the function diagram of FIG. 2 to which is added a function of repetition of the measured time, which function is executed in a step S10 corresponding to the block A illustrated in detail in FIG. 5. This step is intended for the repetition of a chosen number of times of the successive measurement of the same time interval. This function may be programmed on each occasion that it is appropriate to perform a repetitive function. This may correspond to a learning exercise for example.

Step S11 therefore decides, as a function of the parameters entered during the programming of the display device, whether the time interval has to be repeated and, if it does, how many times. After each repetition, the display is reset to zero in step S12 before the countdown recommences. After the last programmed repetition, we go to the stopping of the device in step S13 in the course of which the display flashes, for example three times, before going off, signaling to the user the end of the measured interval. Of course, the repetition could also be controlled manually so as to enable the user to stop the repetition at will and not by fixing the number of repetitions in advance.

As was mentioned previously, the remote control 3 comprises a transmitter/receiver. In a preferred form of execution of the display device which is the subject of the invention, a second display member, similar to the display member 5 but smaller, will be disposed on the remote control, whose receiver will receive signals arising from the display control 14, enabling another person to monitor the elapsing of the time interval programmed on this display member. This may be useful in particular within the framework of a conference, enabling not only the speaker to view the measurement of the time interval, but also the chairman whose job is in particular to make sure that the schedule and hence the speaking times allocated to the conference participants for their lectures are complied with.

Although in the above examples it has been mentioned that the first portion of the time interval was displayed over a length of the time scale proportional to this portion of the time interval, it would also be possible to arrange for this first portion to be displayed over the whole length of the time scale, like the second portion of this time interval to be measured.

1. A method of displaying programmable-duration time intervals along a time scale of given length, with the aid of a cursor which moves from one end to the other of said scale with a speed dependent on the duration of each programmed time interval, wherein said programmed time interval is divided into two respective time portions of different durations and in that at the end of the first of said time portions said cursor is returned to the start of said time scale so as to measure the second of said time portions, in such a way that said cursor traverses said time scale at two substantially different respective speeds.

2. The method as claimed in claim 1, in which the first of said time portions represents the major part of said programmed time interval.

3. The method as claimed in claim 1, in which, at the end of the display of a programmed time interval, the cursor repeats a programmable number of times the display of said time interval.

4. The method as claimed in claim 1, in which the start of the display of a programmed time interval is deferred according to a programmable duration.

5. The method as claimed in claim 1, according to which each of said portions of said programmed time interval is subdivided into a number n of micro-intervals of variable durations.

6. The method as claimed in claim 5, in which the respective durations of said micro-intervals are increasing from the first to the n^{th} of said micro-intervals.

7. A device for displaying programmable-duration time intervals, comprising a time scale of given length, a cursor able to move along said scale and means of control of said cursor to determine its speed of movement as a function of a time interval of determined duration, wherein said programming means comprise means for dividing said time interval into two portions and in that said means of control of said cursor determine the respective speeds of movement of said cursor as a function of the durations of said respective time portions.

8. The device as claimed in claim 7, in which a remote control transmitter/receiver element comprises a time scale whose cursor is controlled by signals emitted by said means of control and picked up by said receiver.
